(19) United States
(12) Patent Application Publication
(10) Pub. No.: US 2003/0045296 A1
(43) Pub. Date: Mar. 6, 2003

(54) Establishing communications between devices within a mobile ad hoc network based on user attributes

(76) Inventor: Jeremy Burr, Portland, OR (US)

Correspondence Address: Timothy N. Trop, TROP, PRUNER & HU, P.C., STE 100, 8554 KATY FWY, HOUSTON, TX, 77024-1805, US

(21) Appl. No.: 09/948,270

(22) Filed: Sep. 6, 2001

(51) Int. Cl. H04Q 7/20

(52) U.S. Cl. 455/445; 455/421; 455/11.1

(57) ABSTRACT

A mobile ad hoc network may be established between a plurality of devices that have common attributes. The attributes may, for example, be working for the same company, belonging to the same organization or attending the same school. Information about common attribute devices may be progressively shared, using a bucket brigade technique of sharing information between in-range devices. Status information about the devices in the network may be similarly shared in a bucket brigade fashion. Thus, the network is dynamic in the sense that at any given time, it may be determined whether any given device in the network is active. Moreover, the links are established between a manageable number of devices defined by having common attributes with one another.

### BACKGROUND

This invention relates generally to communication systems and particularly to establishing links between individuals on a wireless communication network.

A mobile ad hoc network (MANET) is an autonomous system of mobile routers and associated hosts connected by wireless links, the union of which forms an arbitrary graph. The routers are free to move randomly and organize themselves arbitrarily. Thus, the MANET wireless topology may change rapidly and unpredictably. Such a network may operate in a stand-alone fashion or may be connected to a larger Internet.

A MANET consists of mobile platforms called nodes that are free to move about arbitrarily. MANET nodes may be equipped with wireless transmitters and receivers using antennas which may be omnidirectional (broadcast), highly directional (point-to-point), steerable, or some combination thereof. Generally MANETs are bandwidth-constrained variable-capacity links. Often the nodes are energy-constrained since they may be portable and rely on battery power.

An implicit assumption within a MANET is that every node within the network may wish to communicate with every other node within the network. The MANET protocol defines all devices as routers, and then goes about trying to comprehend how each router maintains real time knowledge about the existence of other routers within the network. This becomes an exponential task to manage as the network increases in size. This problem is compounded by the ability of the nodes to dynamically enter or leave the network in an “ad hoc” fashion. The ad hoc nature of the network creates an onerous network management problem, flooding the network with status packages requiring constant updates.

There are a number of postulated causes for MANET network failure. The network updates may not be received fast enough to keep up with dynamic changes. The information about which nodes are currently connected to the network may become so out of date that it is no longer trustworthy. The network updates may consume so much of the available bandwidth that there may be insufficient residual bandwidth for actual data to traverse the network. The battery life of each node may be insufficient because of the volume of update traffic, which requires the node to be almost permanently communicating with other devices in order to obtain network status information. A routing table that contains the information about how to traverse from one node to another may become so large that it may not be stored in the available memory capacity of nodes within the network.

Thus, there is a need for better ways to manage a mobile ad hoc network.

### BRIEF DESCRIPTION OF THE DRAWINGS

FIG. 1 is a schematic depiction of a mobile ad hoc network in accordance with one embodiment of the present invention;

FIG. 2 is a block depiction of a node in a mobile ad hoc network in accordance with one embodiment of the present invention;

FIG. 3 is a flow chart for software in accordance with one embodiment of the present invention; and

FIG. 4 is a flow chart in accordance with another embodiment of the present invention.

### DETAILED DESCRIPTION

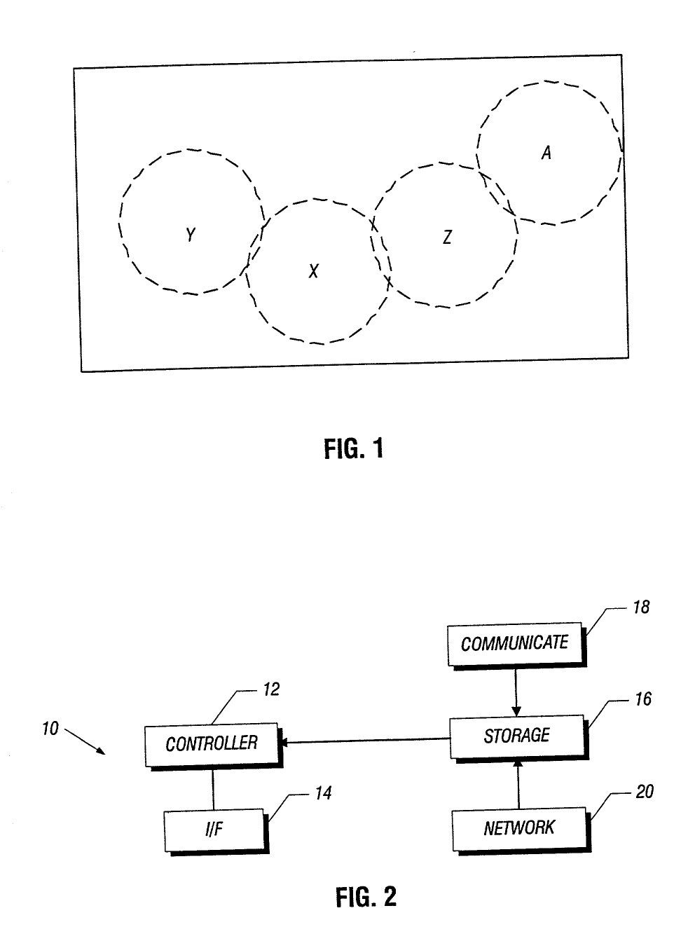

Referring to FIG. 1, a mobile ad hoc network (MANET) may be established between a plurality of mobile devices, such as the devices X, Y, Z and A. Each device X, Y, Z and A may be a wireless transceiver. The wireless transceivers may use any available wireless protocol including the Bluetooth specification (Specification of the Bluetooth System, Version 1.1, Feb. 22, 2001) and 802.11 specification (IEEE Standard 802.11 available from the Institute of Electrical and Electronics Engineers, New York, N.Y.). In some embodiments they may be mobile battery powered devices. Each device generally has a limited range indicated by the dashed circles.

Instead of trying to communicate with every single device in the network, which commonly may be a very large number of devices, a network is established with a smaller group of devices within the network. Each device includes a contact list. A contact list may be a list of individuals with whom the device has communicated in the past. Contact lists are commonly stored on computers. For example, on Microsoft Explorer®, contact lists may be maintained. Similarly, lists of addressees may be maintained with a variety of software including scheduling and information management software. Thus, each device X, Y, Z or A in this example, may have its own contact list.

In order to establish a network, each of the devices may exchange its contact list with any in-range devices. For example, the devices X and Y are both in-range and may exchange contact lists. Each device X or Y may then determine, in one embodiment, whether they may have common entries on their contact lists. This common entry information may be stored. Thereafter, the devices Y and Z may exchange contact lists and determine which devices are in common on each of their contact lists. In addition, the device Y may store information about which contacts on Z's contact list are also on X's contact list. The devices Z and A may then exchange contact lists and a determination may be made about what are their common contacts. Z may also determine which contacts on A's list are also on Y's list.

Thus, the device X's contact list includes at least Y. The Y's contact list includes at least X and Z and Z's contact list includes at least Y and A. Finally, A's contact list includes at least Z.

In accordance with one embodiment of the present invention, a MANET may be established within a smaller defined group, which is therefore much more manageable. The smaller defined group may be established by exchanging contact lists and establishing communication links from a first station, such as the station X with other stations which may or may not be in-range, but are determined to have common contacts in their contact lists. Thus, even though the device Z is out-of-range from the device X, the device X may establish a communication link through their common contact Y, to out-of-range device Z and ultimately to out-of-range device A.

Devices determine which common contacts they have and this common contact information may traverse the network as the network grows over time. This common contact information may be stored in a routing table, which in one embodiment may be available on each device within the MANET. Also, stored is information about whether or not a particular device is currently on-line.

In some embodiments, still additional profile information may be transferred and stored, such as the device's identifier, a profile of personal information about the device owner, alternative routes to each device on-line, and identifying adjacent devices for a first hop and the number of hops to the destination device. Also, stored in some embodiments, may be information about the type of each device, such as whether it is an audio, text, phone, still picture capable device, and the like.

This shared information may traverse across the network by being progressively exchanged between in-range devices. As status information changes, for example, whether or not a given device is on-line or not, that information may be shared around the network.

Additional profile information may be utilized to create a viable universe of participants within a MANET. For example, in some embodiments, in addition to establishing a MANET among devices with common contact list entries, additional participants may be added based on other common attributes. The common attributes may be various user attributes including individuals that work for the same company, individuals who belong to the same club, individuals who belong to a given organization, individuals attending the same school and individuals having other predefined characteristics. In some cases, individuals with the attribute may have an identifier, password or code that identifies them as actually having the asserted attribute.

In some embodiments, the common attribute may be utilized exclusively to define the MANET participants. In other embodiments, the common attribute may be utilized in conjunction with the common contacts list information to define a MANET.

In either case, the generation and establishment of the network may be similar. However, the number of participants who qualify may be different in each case. Thus, in some cases, it may be desirable to include more participants and in other cases, a sufficient network may be established with a fewer number of participants. In some cases, the attribute may be a permanent attribute and in other cases, the attribute may be temporary. For example, attendees of a given trade show may be given a temporary attribute and identifier that allows them to participate in a network with other trade show participants.

A device 10 such as one of the devices indicated as X, Y, Z or A in FIG. 1 may include a controller 12 as indicated in FIG. 2. The controller 12 may communicate with a wireless interface 14. It may also communicate with a storage device 16 that stores the communicate software 18 and the network software 20 in accordance with one embodiment.

The device 10 may be a radio, a cellular phone, a personal digital assistant, a personal computer, or any processor-based device. The network may be established over the Internet, a telephone network or a radio frequency network as a few examples.

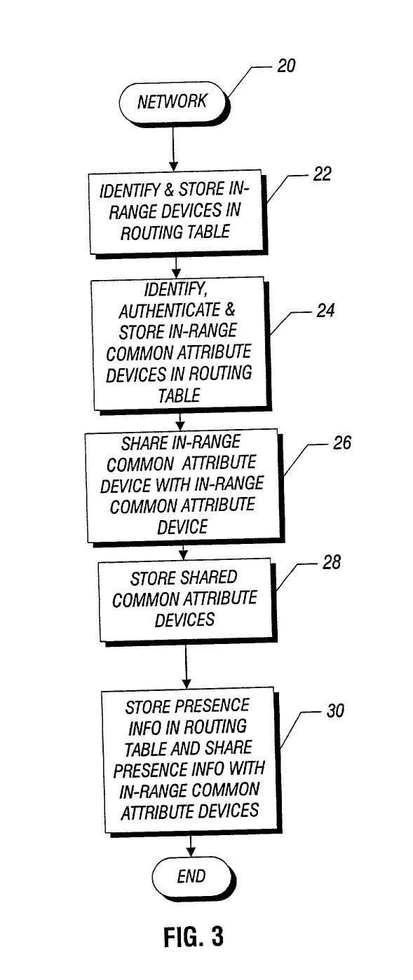

The network software 20 shown in FIG. 3, in one embodiment, begins by identifying and storing in-range devices as indicated in block 22. This in-range device information may be stored in a routing table stored in the storage 16 in one embodiment.

In a similar fashion, in-range devices with common attributes may be identified and authenticated and thereafter stored in the routing table as indicated in block 24. The devices with common attributes may be identified as in-range and may be authenticated as having a common attribute based on an identifier, password or code word that may be exchanged in some embodiments.

In some embodiments, common contacts between in-range devices may also be determined. This may be done by exchanging common contact lists, identifying contacts that are common, and storing that information in the routing table as indicated in block 24. Thus, in some embodiments, the routing table may store not only in-range devices, and devices with common contacts, but may also store devices whose users have common attributes.

The common attribute devices identified among a first set of devices may then be shared with other in-range devices that have common attributes as indicated in block 26. The mutual common attribute devices are then stored in the routing table. In some embodiments, the routing table may also store devices with common contacts.

Next, the mutual common attribute devices, whether they are in-range or not, are stored in the routing table as indicated in block 28. The out-of-range common contacts may be obtained by the progressive sharing throughout the network of information of common attribute devices between devices that are in-range. Eventually this information reaches out-of-range common attribute devices.

Finally, the status information for each device in the network of common attribute devices is stored. This status information may include whether a particular device is currently active or available for receiving communications and that information is similarly shared with in-range common contacts, eventually reaching out-of-range common contacts as indicated in block 30.

Thus, through the sharing of information between devices with common attributes, the nature of the network and the status of each device in the network may be dynamically updated on an ongoing basis. As soon as one device is determined to no longer be active, that information may be gleaned by in-range devices that share the information with in-range devices until the information eventually progresses throughout the network. The common attributes limit the number of devices so that MANET management becomes more workable. Each device may, therefore, develop its own unique subset of the global MANET network. By establishing a MANET of manageable size using common attributes, a more efficient network may be achieved especially because of the likelihood that the common attribute devices will want to contact each other anyway. In other words, a MANET of manageable size is achieved among individuals who are likely to contact each other anyway, avoiding the storage of connection information between devices that are less likely to communicate with one another.

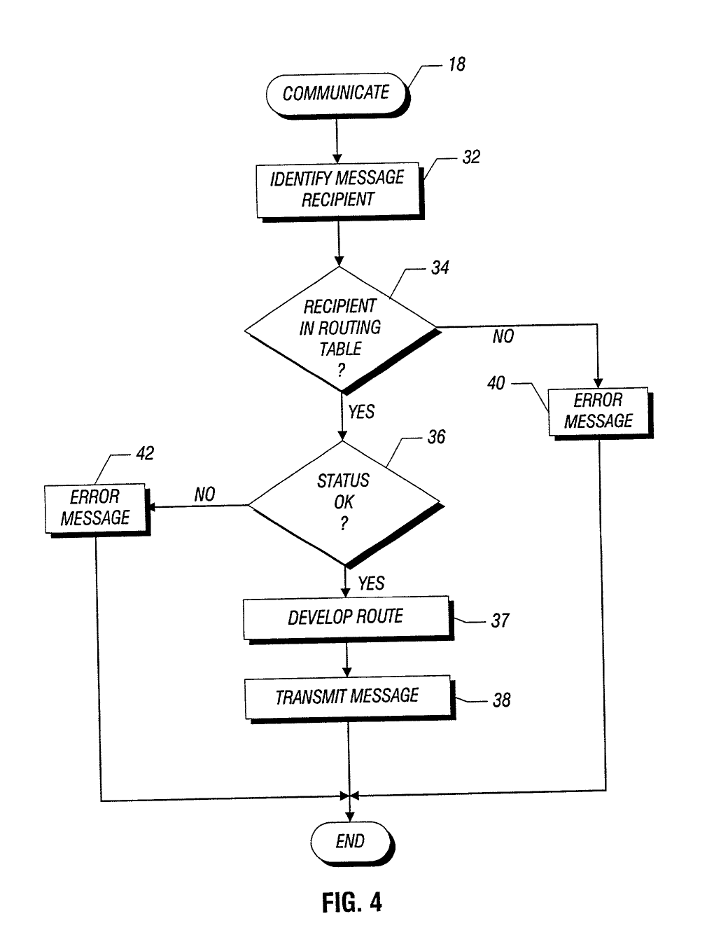

The communicate software 18, shown in FIG. 4, begins by identifying a recipient of a potential message as indicated in block 32 in one embodiment. A check at diamond 34 determines whether the intended recipient is in the routing table. If so, a check of the status information (diamond 36) associated with the intended recipient determines whether or not the device is currently active. If not, an error message may be generated as indicated in block 42.

If the device status is okay a message may be transmitted to the recipient via a series of in-range devices over a path that was stored in the routing table of those devices, as indicated in block 38. If an intended recipient is not on the routing table, an error message may be generated as indicated in block 40. This means that the device is both not in-range and does not have the common attribute with a series of devices that can define a plurality of in-range links to that device.

While the present invention has been described with respect to a limited number of embodiments, those skilled in the art will appreciate numerous modifications and variations therefrom. It is intended that the appended claims cover all such modifications and variations as fall within the true spirit and scope of this present invention.

What is claimed is:

1. A method comprising:
identifying devices within a network that are being used by individuals having a predetermined attribute in common, including a first device in-range from a second device and a third device being out-of-range from the second device;
automatically establishing a communication route from the second device to the first device; and
automatically establishing a communication route from the second device to the third device through the first device.

2. The method of claim 1 including exchanging information about devices with common attributes with other in-range devices.

3. The method of claim 1 including storing information sufficient to establish a communication route from said second device to said third device.

4. The method of claim 3 including storing information about whether said third device is active.

5. The method of claim 1 including periodically updating information about in-range devices.

6. The method of claim 1 including authenticating devices to ensure that they have the predetermined attribute.

7. The method of claim 6 including requesting a password to establish a predetermined attribute.

8. The method of claim 1 including obtaining a list of known contacts on a wireless device and determining whether two devices in said network have common contacts.

9. The method of claim 1 including enabling a device to establish a communication route based on a temporary predetermined attribute.

10. The method of claim 1 including forwarding communications between said first, second and third devices over a telephone network.

11. An article comprising a medium storing instructions that enable a processor-based system to:
identify devices within a network that are being used by individuals having a predetermined attribute in common, including a first device in-range from a second device and a third device being out-of-range from the second device;
automatically establish a communication route from the second device to the first device; and
automatically establish a communication route from the second device to the third device through the first device.

12. The article of claim 11 further storing instructions that enable the processor-based system to exchange information about devices with common attributes with other in-range devices.

13. The article of claim 11 further storing instructions that enable the processor-based system to store information sufficient to establish a communication route from said second device to said third device.

14. The article of claim 13 further storing instructions that enable the processor-based system to store information about whether said third device is active.

15. The article of claim 11 further storing instructions that enable the processor-based system to periodically update information about in-range devices.

16. The article of claim 11 further storing instructions that enable the processor-based system to authenticate devices to ensure that they have the predetermined attribute.

17. The article of claim 16 further storing instructions that enable the processor-based system to request a password to establish a predetermined attribute.

18. The article of claim 11 further storing instructions that enable the processor-based system to obtain a list of known contacts on a wireless device and determine whether two devices in said network have common contacts.

19. The article of claim 11 further storing instructions that enable the processor-based system to enable a device to establish a communication route based on a temporary predetermined attribute.

20. The article of claim 11 further storing instructions that enable the processor-based system to forward communications between said first, second and third devices over a telephone network.

21. A system comprising:
a processor; and
a storage coupled to said processor storing instructions that enable the processor to:
identify devices within a network that are being used by individuals having a predetermined attribute in common, including a first device in-range from a second device and a third device being out-of-range from the second device;
automatically establish a communication route from the second device to the first device; and
automatically establish a communication route from the second device to the third device through the first device.

22. The system of claim 21 wherein said storage stores instructions that enable the processor to exchange information about devices with common attributes with other in-range devices.

23. The system of claim 21 wherein said storage stores instructions that enable the processor to store information sufficient to establish a communication route from said second device to said third device.

24. The system of claim 23 wherein said storage stores instructions that enable the processor to store information about whether said third device is active.

25. The system of claim 21 wherein said storage stores instructions that enable the processor to periodically update information about in-range devices.

26. The system of claim 21 wherein said storage stores instructions that enable the processor to authenticate devices to ensure that they have the predetermined at tribute.

27. The system of claim 26 wherein said storage stores instructions that enable the processor to request a password to establish a predetermined attribute.

28. The system of claim 21 wherein said storage stores instructions that enable the processor to obtain a list of known contacts on a wireless device and determine whether two devices in said network have common contacts.

29. The system of claim 21 wherein said storage stores instructions that enable the processor to enable a device to establish a communication route based on a temporary predetermined attribute.

30. The system of claim 21 wherein said storage stores instructions that enable the processor to forward communications between said first, second and third devices over a telephone network.
